(19) United States
(12) Patent Application Publication
(10) Pub. No.: US 2007/0062013 A1
(43) Pub. Date: Mar. 22, 2007

(54) Clip device

(76) Inventor: Paula Gwen Willis Mueller, Valencia, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/234,510

(22) Filed: Sep. 22, 2005

(51) Int. Cl. F16B 45/02

(52) U.S. Cl. 24/599.1

(57) ABSTRACT

A carabiner device incorporating a handle assembly for gripping. In one aspect, the handle is removed from a latch assembly and holding or storing structure of the carabiner.

### BACKGROUND OF THE INVENTION

The present invention is directed towards a holding or storing apparatus, and more particularly to a carabiner device including a handle.

Carabiner devices have been found to have a multiple of uses. The carabiner was first used and got its name from carbine guns which used a spring-loaded gate. Carabiners have today developed into a useful product.

Traditionally, climbers have used carabiners to hold ropes and to function as an aid in scaling small or great heights. Sailors have likewise found a use for the combination of a clip and spring loaded gate during sailing.

More recently, miniature carabiners have been used as key chains. The use of carabiners as key chains has grown so much in popularity that one can find carabiner key chains in a myriad of ornamental designs ranging from hearts to animals.

Carabiners are also useful around the home and as a work tool. Cables, wires and ropes can be stored and hung on carabiners. Devices can be carried using carabiners configured with a grip.

The prior devices have been found to be lacking in providing sufficient space for storing or carrying items as well as for a person's hand or grip. The person using conventional carabiners must use the same space intended to store items to grip the device. There is often insufficient room for the person's hand or the hand is subjected to impact with the stored or carried devices. Moreover, when attempting to quickly latch the carabiner about structure, the operator's hand can become an obstruction. In smaller devices, there lack structure separate from the body of the carabiner for grasping by fingers.

Accordingly, the present invention provides a carabiner assembly with structure to remove a person's hand from the storing and holding function of a body of the carabiner. The present invention contemplates various approaches to accomplish the same and thus accomplishes addressing these and other needs.

### SUMMARY OF THE INVENTION

Briefly and in general terms, the present invention is directed towards a carabiner assembly including a handle assembly. In one aspect, the carabiner includes a body and a spring biased latch assembly having an open and a closed position. When the latch is in the closed position, the body defines a closed loop and the handle assembly is positioned exterior the closed loop.

In one particular embodiment, the carabiner assembly of the present invention includes a handle assembly that defines a loop exterior of a loop defined by a body of the carabiner assembly. The body of the carabiner assembly is designed to receive and hold items or function as a releasable grip. In another embodiment, the handle assembly includes a first end attached to the body of the carabiner assembly and a second free unattached to the body.

The handle assembly can be attached to the body of the carabiner assembly in a number of ways. In one aspect, the handle assembly forms a generally rigid loop structure that is welded or otherwise affixed to the body. In another aspect, the handle assembly is slidable along a member forming the body of the carabiner assembly and is formed from flexible material. A grip sized to be comfortably gripped by hand can further be provided on the handle.

In other aspects, the carabiner assembly can include additional loops and the handle can further include a ring for storing items. Further, the body of the carabiner assembly is contemplated to embody a plurality of spring based latch assemblies having open and closed configuration and providing access to an interior of the body sized and shaped for storing or receiving items.

Various shapes of the members defining the body of the carabiner are contemplated. Moreover, various substitutions of handles and latch assemblies are contemplated to be incorporated into one or more of the assemblies described.

Other features and advantages of the present invention will become apparent from the following detailed description taken in conjunction with the accompanying drawing, which illustrates, by way of example, the principles of the invention.

### BRIEF DESCRIPTION OF THE DRAWINGS

FIG. 1 is a front view, depicting one embodiment of a clip device of the present invention;

FIG. 2 is a front view, depicting a second embodiment of a clip device of the present invention;

FIG. 3 is a front view, depicting a third embodiment of a clip of the present invention;

FIG. 4 is a front view, depicting a clip device including a looped structure;

FIG. 5 is a front view, depicting a clip device incorporating a plurality of spring biased latch assemblies;

FIG. 6 is a perspective view, depicting a clip device including a handle with a free end and a spring biased latch assembly in a closed position;

FIG. 7 is a perspective view, depicting the clip device of FIG. 6 with the latch assembly in an open position;

FIG. 8 is a front view, depicting a clip device including a flexible handle assembly;

FIG. 9 is a perspective view, depicting the flexible handle assembly removed from the clip device of FIG. 8; and

FIG. 10 is a side view, depicting disassembled components of the flexible handle assembly of FIG. 9.

### DETAILED DESCRIPTION OF THE INVENTION

Referring now to the drawings which are provided by way of example and not limitation, the present invention is embodied in a clip device including at least one spring loaded latch or gate assembly. The clip assembly of the present invention is useful for a myriad of purposes including holding and storing items or while climbing and sailing.

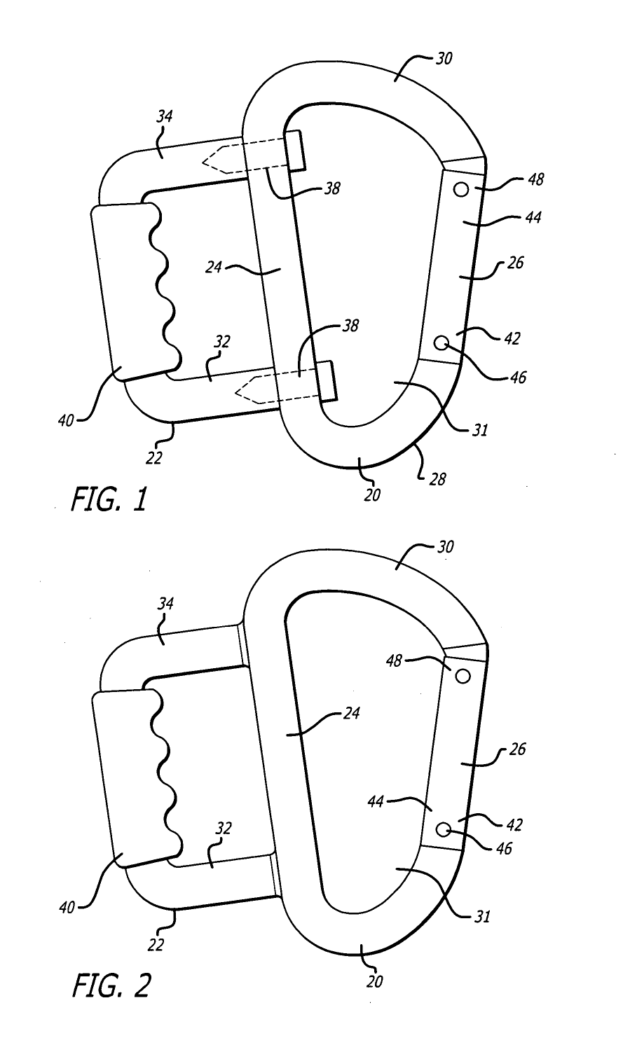

In one particular embodiment, the clip device includes a body 20 and a handle 22 attached to the body 20 (See FIG. 1). The body can take on a number of shapes and forms. In the depicted embodiment, the body 20 is formed from a solid cylinder or tubular structure. The body 20 includes a pair of generally straight longitudinal members 24, 26 connected to each other at their end portions by a first 28 and a second 30 curved member, respectively, to form a closed or closeable loop having an interior 31. The first and second curved members 28, 30 can have similar or as depicted, different radii of curvature.

Additionally, the handle 22 can be affixed anywhere along the body 20 of the clip device by connecting means or can be formed integral to the body 20. As shown in FIG. 1, the handle 22 includes a first post 34 attached to the first longitudinal member 24 and a second post attached to the first longitudinal member 24 by screws 38. The screws 38 can be advanced or placed through threaded or non-threaded holes formed in the body 20 and into threaded holes formed in the posts 34, 36. The handle 22 can additionally be equipped with a grip 40 which can be produced by conventional means such as molding.

Notably, the handle 22 forms a looped structure adjacent to the body 20 and exterior the interior 31 of the body loop. In this way, the handle 22 can be gripped by hand while maintaining the hand spaced from items or material being held by the body 20.

The second longitudinal member or component 26 of the body 20 includes a spring biased latch or gate assembly 42. Such latch or gate assemblies 42 are commonly found in conventional carabiners. That is, the latch assembly 42 includes an arm 44 that is rotatable about a fixed point 46 and further includes a terminal end 48 that is received within mating structure formed in the body 20.

Moreover, the latch 42 is spring biased to a closed position and is capable of opening inwardly and to within the body interior 31 when a force is applied thereto. As such, items can be placed within the interior 31 and the forces such as those created from the weight of the items held with the body interior 31, aids in maintaining the latch assembly 42 in a closed position.

Turning now to FIG. 2, there is shown a second embodiment of a clip device. In the embodiment shown in FIG. 2, the handle assembly 22 is welded or similarly attached to the body 20.

Again, the handle 22 forms a looped structure outside of the interior 31 of the body 22 to thereby avoid interference between a person's hand and items placed within the interior 31. As with the embodiment of FIG. 1, the latch assembly 42 includes an arm 44 that is rotatable about a fixed point 46 and further includes a terminal end 48 that is received within mating structure formed in the body 20.

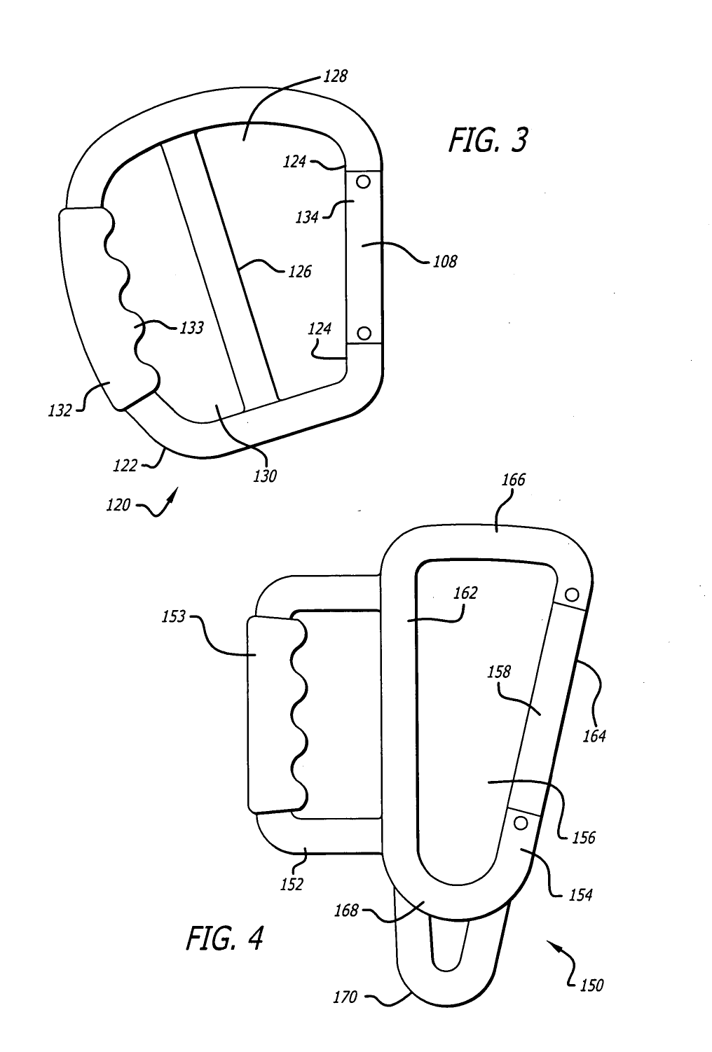

Turning now to FIG. 3, another embodiment of a clip device 120 is depicted. In this embodiment, the clip device 120 has a generally C-shaped member 122 having a pair of spaced termed ends 124. The clip device 120 further includes a cross bar 126 extending across the C-shaped device. The cross bar 126 can be attached by any conventional means, such as welding, to the C-shaped member 122 or can form an integral component of the device 120.

The positioning of the cross bar 126 is selected to thereby define an interior 128 space for releasably holding objects and a second space 130 sized to accept a person's hand. A handle 132 is defined by a portion of the C-shaped member 122 extending between endpoints of the cross bar 126. A grip 133 can be provided on the handle for the convenience and comfort of the operator.

A rotatable spring-loaded latch 134 is configured between the endpoints or terminal ends 124 of the C-shaped member 122. As before, the spring-loaded latch 134 is biased to a closed position and is rotatable within the interior 128 of the device 120 against the applied spring force.

With reference to FIG. 4, there is shown yet another embodiment of a clip device 150. The clip device includes a handle 152 attached to a body 154 having an interior 156, the handle 152 being configured exterior the interior 156. As before, the handle 152 can be equipped with a grip 153. The body 154 further includes a spring biased latch or gate assembly 158.

The body 154 includes first 162 and second 164 longitudinal members which are attached to each other at their ends by a first end member 166 and a second end member 168, respectively. The first 166 and second 168 members can assume a number of sizes, shapes and configurations. In FIG. 4, the first end member 166 is a generally straight member having curved ends. The second end member 168 is curved along its length and spans a smaller distance than the first member 166 to thereby provide the clip device 150 with an overall triangular shape.

The clip device 150 further includes a looped structure 170 attached to the second member 168. The looped structure 170 is configured exterior the interior 156 of the device and can be used for hanging or grasping.

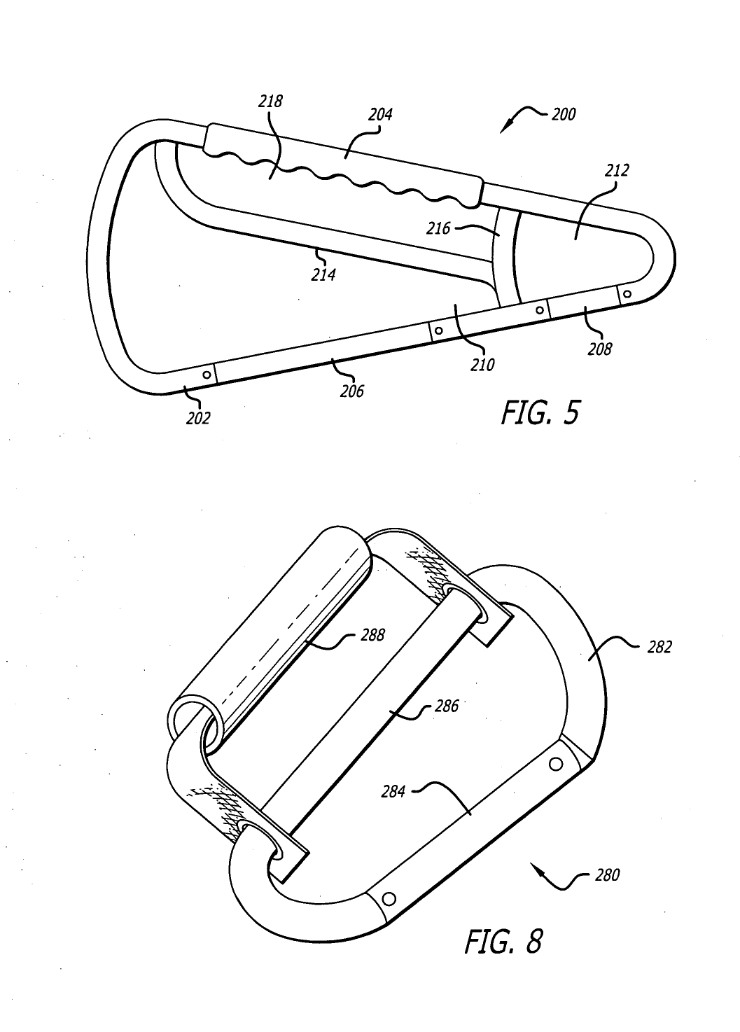

In another aspect of the invention (FIG. 5), a clip device 200 can include a body 204, a handle 207 attached to the body 202 and a plurality of spring biased latch or gate assemblies. In the depicted embodiment, the clip device 200 includes a first latch assembly 206 and a second latch assembly 208. The first latch assembly 206 provides access to a first interior space 210 for holding or receiving structure and the second latch assembly 208 provides access to a second interior space 212 for holding or receiving structure.

The overall shape of the clip device 200 can assume a number of configurations. As shown in FIG. 5, the handle 204 forms a member that is continuous with member's forming a portion of the second interior 212 but it is to be understood that the handle can assume the configuration of any of the disclosed embodiments. A pair of internal members 214, 216 help to define the interior spaces 210, 212 as well as the space 218 intended for an operator's hand.

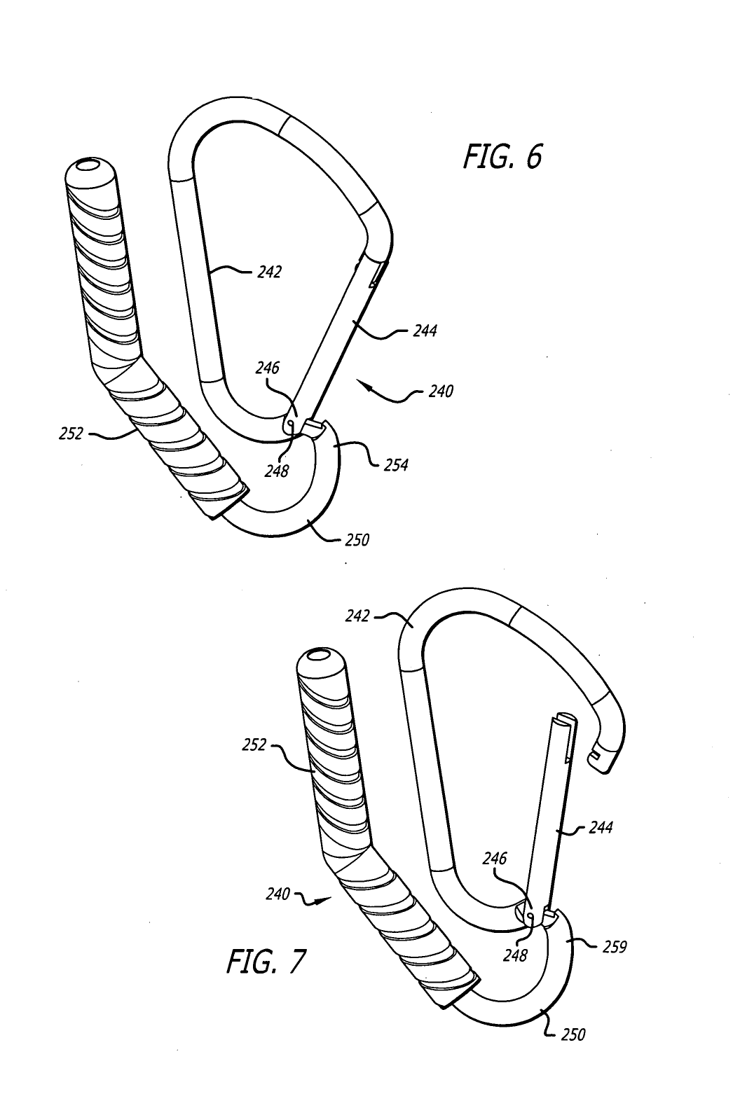

In yet another aspect of the invention, a clip device 240 can include a body 242 including a spring biased latch assembly 244 having closed and open configurations (See FIGS. 6 and 7, respectively). One end 246 of the latch assembly 244 is rotatably attached to the body 242 at a point of rotation 248.

Fixedly joined to the body 242 adjacent the point of rotation 240 is a handle 250. The handle 250 includes a free end portion 252 equipped with a grip and a second end portion 254 which is joined to the body 242. As is consistent with prior embodiments, the handle 250 is configured exterior an interior space defined by the members of the body 242.

With reference to FIGS. 8-10, there is shown a clip device 280 including a body 282 equipped with a spring biased latch or gate assembly 284. Along a body member 286 spaced from the latch assembly 284 is a flexible handle assembly 288.

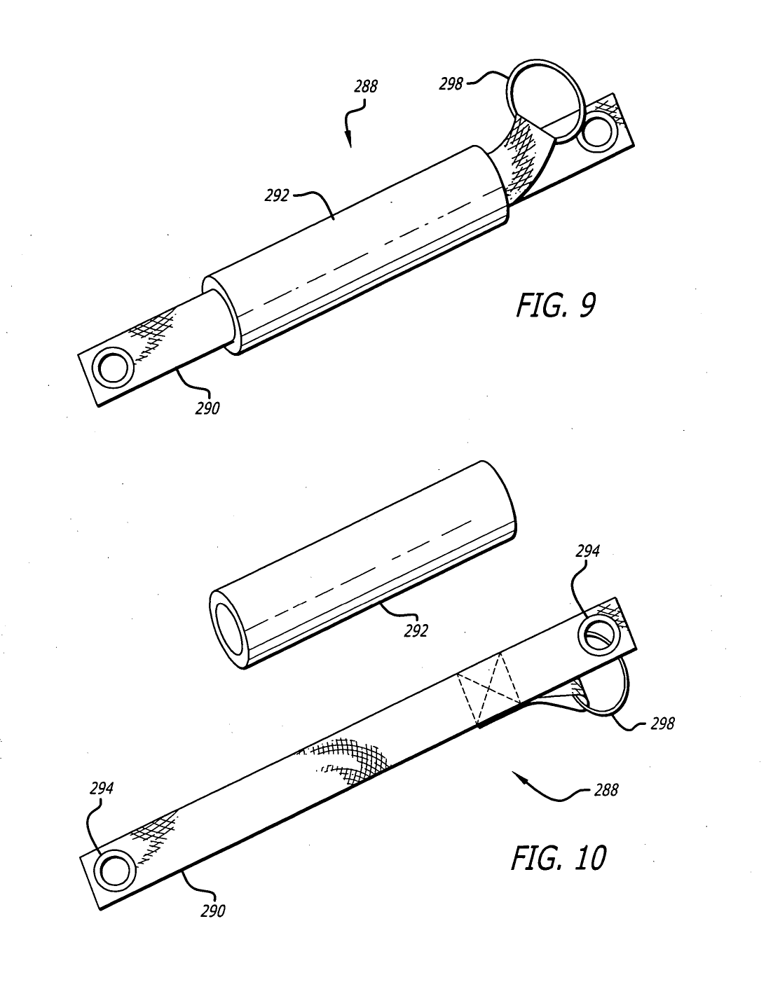

As best seen in FIGS. 9 and 10, the handle assembly 288 includes an internal belt assembly 290 about which a handle grip 292 is configured. In one embodiment, the belt assembly 290 can be made from a nylon web. The belt 290 further includes a pair of spaced eyelets 294 sized to receive the body member 286 which is spaced from the latch assembly 284. In one aspect, the handle assembly 288 can be made to slide along the body member 286 or alternatively, it can be made to be fixed in position. Further, the internal belt assembly 290 can additionally include a key ring 298 for use in a manner acceptable to the user.

Accordingly, the present invention provides a clip assembly device intended to be useful in a number of applications. In one particular aspect, the clip assembly includes a handle providing a gripping surface separate and exterior from the holding or gripping formation of the various clip device disclosures. It is to be recognized that each of the various described features of the clip device can be incorporated into any of the other clip devices so that any one particular device can include one or more latch assemblies, looped structures and handles. Moreover, the members defining the clip devices of the present invention can be formed from hollow tubes or solid cylindrical structures and can further have various other cross sectional profiles such as square, rectangular, curved or polygonal.

Thus, it will be apparent from the foregoing that, while particular forms of the invention have been illustrated and described, various modifications can be made without parting from the spirit and scope of the invention.

We claim:

1. A carabiner assembly, comprising:
a body, the body including a first generally longitudinal member spaced from a second generally longitudinal member, the second longitudinal member including a spring based latch assembly having an open position and a closed position, the body defining a first loop when the latch assembly is in a closed position; and
a handle assembly, the handle assembly being attached or configured adjacent to one of the first or second generally longitudinal members, the handle residing exterior of the first closed loop.

2. The carabiner of claim 1, wherein the handle assembly defines a second closed loop.

3. The carabiner of claim 1, wherein the handle is welded to the first generally longitudinal member.

4. The carabiner of claim 1, wherein the handle is affixed to the first generally longitudinal member by screws.

5. The carabiner of claim 1, wherein the handle includes a molded grip.

6. The carabiner of claim 1, wherein the first and second longitudinal members each include first and second end portions and the body further includes a first curved member connecting the first ends of the first and second longitudinal members and a second curved member connecting the second ends of the first and second longitudinal members.

7. The carabiner of claim 6, further comprising a second closed loop attached to one of the first or second curved members.

8. The carabiner of claim 1, wherein the handle forms an integral part of the carabiner assembly.

9. The carabiner of claim 1, wherein the handle assembly is attached to the first generally longitudinal member, the first generally longitudinal member being positioned between the handle assembly and the second longitudinal member.

10. The carabiner of claim 1, wherein the handle assembly includes a first end attached to the body and a second free end.

11. The carabiner of claim 10, wherein the first end is attached to the body at a point where the spring biased latches is rotatably attached to the body.

12. The carabiner of claim 1, wherein the handle assembly is slidable with respect to the body.

13. The carabiner of claim 12, wherein the handle is slidable along the first generally longitudinal member.

14. The carabiner of claim 13, wherein the handle includes first and second eyelets each sized to receive the first generally longitudinal member.

15. The carabiner of claim 14, wherein the handle further includes a nylon web internal component about which is configured a grip.

16. The carabiner of claim 15, wherein the handle further includes a key ring tab.

17. The carabiner of claim 1, wherein the handle is formed from self-supporting, generally rigid material.

18. The carabiner of claim 1, wherein the handle is sized to receive an entire width of user hand.

19. The carabiner of claim 1, wherein the carabiner assembly further includes a second spring biased latch having open and closed configurations.

20. The carabiner of claim 9, wherein the carabiner assembly further includes a cross member defining a second closed loop when the second spring biased latch is in the closed configuration.
